(19) United States
(12) Patent Application Publication
(10) Pub. No.: US 2017/0261800 A1
(43) Pub. Date: Sep. 14, 2017

(54) PROTECTIVE CIRCUIT AND LIQUID CRYSTAL DISPLAY HAVING THE PROTECTIVE CIRCUIT

(71) Applicant: Shenzhen China Star Optoelectronics Technology Co., Ltd., Shenzhen, Guangdong (CN)

(72) Inventors: Xianming ZHANG, Shenzhen, Guangdong (CN); Ping-sheng KUO, Shenzhen, Guangdong (CN); Ming-wei CHEN, Shenzhen, Guangdong (CN)

(73) Assignee: Shenzhen China Star Optoelectronics Technology Co., Ltd., Shenzhen, Guangdong (CN)

(21) Appl. No.: 14/908,093

(22) PCT Filed: Sep. 18, 2015
(86) PCT No.: PCT/CN2015/090022

§ 371 Date: Jan. 27, 2016

(30) Foreign Application Priority Data
Sep. 9, 2015 (CN) 201510571999.X

(51) Int. Cl. G02F 1/1345; G09G 3/36; H02H 3/08

(52) U.S. Cl. CPC G02F 1/13454; H02H 3/08; G09G 3/3648; G02F 2201/50; G09G 2310/08; G09G 2330/04

(57) ABSTRACT

The present invention provides a protective circuit, employed to protect a liquid crystal display, and the liquid crystal display includes a display panel and a level translator providing a clock signal to the display panel through an output line, and the protective circuit includes a first transistor, a detection circuit and a controller coupled to both the first transistor and the detection circuit, and the first transistor is electrically coupled to the detection circuit and the output line, and the clock signal is outputted to the display panel through the first transistor, and the detection circuit detects the clock signal and determines whether the clock signal is normal or not, and as the clock signal is abnormal, the controller controls the level translator to stop outputting the clock signal to the display panel.

### CROSS REFERENCE

This application claims the priority of Chinese Patent Application No. 201510571999.X, entitled “Protective circuit and liquid crystal display having the protective circuit”, filed on Sep. 9, 2015, the disclosure of which is incorporated herein by reference in its entirety.

### FIELD OF THE INVENTION

The present invention relates to a display skill field, and more particularly to a protective circuit and a liquid crystal display having the protective circuit.

### BACKGROUND OF THE INVENTION

In prior art, in the Gate driver on Array (GOA) units, the level translator is employed to generate a clock signal and provides the clock signal to be used for the display panel in most cases. However, in the GOA circuit according to prior art, due to that the frame is not tightly sealed or other process causes, the clock signal generated by the level translator can be easily shorted as outputting, which enlarges the current to result in the burning of the display panel, or ever cause a fire. At present, a large amount of Over Current Protection (OCP) circuit is employed to protect the GOA units. As an illustration, the OCP protection is implemented in Boost circuit, and the protection is performed mainly relying on detecting the peak value of the inductor current. Nevertheless, the OCP circuit cannot function well, and the created tolerance is larger. It is possible to cause malfunction or cannot protect in time when the protection is necessary.

### SUMMARY OF THE INVENTION

The present invention provides a protective circuit and a liquid crystal display having the protective circuit, which can detect the clock signal which the level translator provides to the display panel, and short the clock signal in time as it is abnormal, and thus to effectively protect the display panel.

In one aspect, the present invention provides a protective circuit, employed to protect a liquid crystal display, and the liquid crystal display comprises a display panel and a level translator providing a clock signal to the display panel through an output line, wherein the protective circuit comprises a first transistor, a detection circuit and a controller coupled to both the first transistor and the detection circuit, and the first transistor is electrically coupled to the detection circuit and the output line, and the clock signal is outputted to the display panel through the first transistor, and the detection circuit detects the clock signal and determines whether the clock signal is normal or not, and as the clock signal is abnormal, the controller controls the level translator to stop outputting the clock signal to the display panel.

The detection circuit comprises a mirror current source, a resistor and comparator, and the clock signal is a current, and the mirror current source detects a current outputted by the level translator, and the current flows through the resistor and grounded, and the comparator compares a voltage corresponding to the current with a reference voltage, and as the voltage is larger than the reference voltage, the comparator determines that the current outputted by the level translator is abnormal.

As the voltage is less than or equal to the reference voltage, the comparator determines that the output current of the level translator is normal, and the clock signal is continuously outputted to the display panel.

The first transistor is a P channel MOS (Metal Oxide Semiconductor) transistor.

The output line comprises a high voltage level node, an output node and a low voltage level node which are positioned in order, and a gate of the first transistor and is electrically coupled to the mirror current source of the detection circuit and the controller, and a drain of the first transistor is electrically coupled to the high voltage level node, and a source of the first transistor is electrically coupled to the output node; the controller can control the first transistor to be activated or to be deactivated, and as the controller controls the first transistor to be activated, the current flows from the high voltage level node to the output node through the first transistor to be provided to the display panel.

One end of the mirror current source is electrically coupled to the high voltage level node and the drain of the first transistor, and the other end is electrically coupled to the gate of the first transistor and the controller, and the mirror current source is further grounded through the resistor.

The protective circuit further comprises a second transistor, and the second transistor is electrically coupled to the output line, the first transistor and the controller, and the controller controls the second transistor to be activated to short the clock signal.

The second transistor is a N channel MOS transistor.

A gate of the second transistor is electrically coupled to the controller, and a source of the second transistor is electrically coupled to the low voltage level node, and a drain of the second transistor is electrically coupled to the output node and a gate of the first transistor.

In another aspect, the present invention provides a liquid crystal display comprising a level translator, a display panel and a protective circuit, and the level translator provides a clock signal to the display panel through an output line, and as the clock signal is abnormal, the protective circuit stops outputting the clock signal to the display panel; wherein the protective circuit comprises a first transistor, a detection circuit and a controller coupled to both the first transistor and the detection circuit, and the first transistor is electrically coupled to the detection circuit and the output line, and the clock signal is outputted to the display panel through the first transistor, and the detection circuit detects the clock signal and determines whether the clock signal is normal or not, and as the clock signal is abnormal, the controller controls the level translator to stop outputting the clock signal to the display panel.

The detection circuit comprises a mirror current source, a resistor and comparator, and the clock signal is a current, and the mirror current source detects a current outputted by the level translator, and the current flows through the resistor and grounded, and the comparator compares a voltage corresponding to the current with a reference voltage, and as the voltage is larger than the reference voltage, the comparator determines that the current outputted by the level translator is abnormal.

As the voltage is less than or equal to the reference voltage, the comparator determines that the output current of the level translator is normal, and the clock signal is continuously outputted to the display panel.

The first transistor is a P channel MOS (Metal Oxide Semiconductor) transistor.

The output line comprises a high voltage level node, an output node and a low voltage level node which are positioned in order, and a gate of the first transistor and is electrically coupled to the mirror current source of the detection circuit and the controller, and a drain of the first transistor is electrically coupled to the high voltage level node, and a source of the first transistor is electrically coupled to the output node; the controller can control the first transistor to be activated or to be deactivated, and as the controller controls the first transistor to be activated, the current flows from the high voltage level node to the output node through the first transistor to be provided to the display panel.

One end of the mirror current source is electrically coupled to the high voltage level node and the drain of the first transistor, and the other end is electrically coupled to the gate of the first transistor and the controller, and the mirror current source is further grounded through the resistor.

The protective circuit further comprises a second transistor, and the second transistor is electrically coupled to the output line, the first transistor and the controller, and the controller controls the second transistor to be activated to short the clock signal.

The second transistor is a N channel MOS transistor.

A gate of the second transistor is electrically coupled to the controller, and a source of the second transistor is electrically coupled to the low voltage level node, and a drain of the second transistor is electrically coupled to the output node and a gate of the first transistor.

Compared with prior art, the liquid crystal display having the protective circuit described in the embodiment of the present invention can detect the clock signal current which the level translator provides to the display panel, and compare the voltage corresponding to the clock signal current with the reference voltage to determine whether the clock signal is normal or not according to the comparison result. When the clock signal is abnormal, the output of the clock signal current is short in time, and thus to effectively protect the display panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a partial circuit diagram of a liquid crystal display having a protective circuit according to the embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Besides, the following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the description of the invention, which needs explanation is that the term “installation”, “connected”, “connection” should be broadly understood unless those are clearly defined and limited, otherwise, For example, those can be a fixed connection, a detachable connection, or an integral connection; those can be a mechanical connection, or an electrical connection; those can be a direct connection, or an indirect connection with an intermediary, which may be an internal connection of two elements. To those of ordinary skill in the art, the specific meaning of the above terminology in the present invention can be understood in the specific circumstances.

Besides, in the description of the present invention, unless with being indicated otherwise, “plurality” means two or more. In the present specification, the term “process” encompasses an independent process, as well as a process that cannot be clearly distinguished from another process but yet achieves the expected effect of the process of interest. Moreover, in the present specification, any numerical range expressed herein using “to” refers to a range including the numerical values before and after “to” as the minimum and maximum values, respectively. In figures, the same reference numbers will be used to refer to the same or like parts.

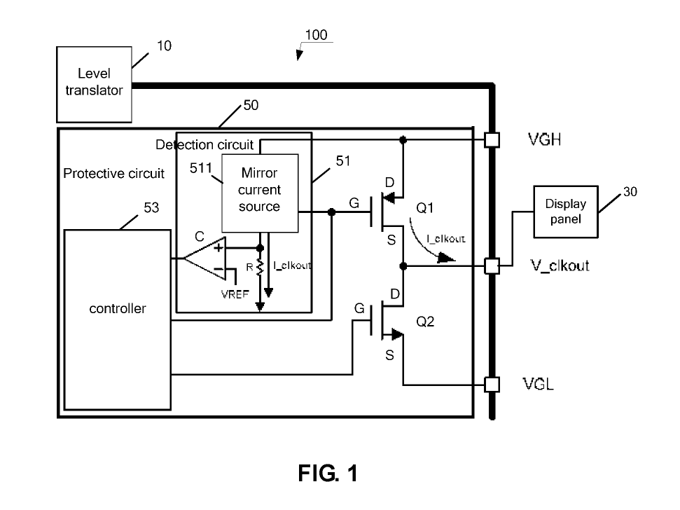

Please refer to FIG. 1. FIG. 1 is a partial circuit diagram of a liquid crystal display having a protective circuit according to the embodiment of the present invention. As shown in FIG. 1, the liquid crystal display 100 comprises a level translator 10, a display panel 30 and a protective circuit 50. The level translator 10 is electrically coupled to the display panel 30 and the protective circuit 50. The level translator 10 can provide a clock signal and transmits the same to the display panel 30 through an output line under the control of the protective circuit 50. In the preferred embodiment, the clock signal can be a clock signal current I-clkout. The output line comprises a high voltage level node VGH, an output node V-clkout and a low voltage level node VGL which are positioned in order.

The protective circuit 50 is electrically coupled to the aforesaid high voltage level node VGH, the output node V-clkout and the low voltage level node VGL, and detects the clock signal outputted by the level translator 10 and determines whether the clock signal is normal or not. When the clock signal is determined to be abnormal, such as to be short, the output of the clock signal to the display panel 30 is stopped, and thus to protect the display panel 30 from damage.

The protective circuit 50 comprises a first transistor Q1, a detection circuit 51, a controller 53 and a second transistor Q2.

Specifically, in the embodiment of the present invention, the first transistor Q1 is a P channel MOS (Metal Oxide Semiconductor) transistor. A gate G of the first transistor Q1 and is electrically coupled to the detection circuit 51 and the controller 53, and a drain D of the first transistor Q1 is electrically coupled to the high voltage level node VGH and the detection circuit 51, and a source S of the first transistor Q1 is electrically coupled to the output node V-clkout. The controller 53 can control the first transistor Q1 to be activated or to be deactivated. As the first transistor Q1 is activated, the clock signal current I-clkout flows from the high voltage level node VGH to the output node V-clkout through the first transistor Q1 to be provided to the display panel 30.

The detection circuit 51 comprises a mirror current source 511, a resistor R and comparator C. One end of the mirror current source 511 is electrically coupled to the high voltage level node VGH and the drain D of the first transistor Q1, and the other end is electrically coupled to the gate G of the first transistor Q1 and the controller 53. Meanwhile, the mirror current source 511 is further grounded through the resistor R. The detection circuit 511 detects a clock signal current I-clkout outputted by the level translator 10. The clock signal current I-clkout flows through the resistor R.

The first input end of the comparator C is coupled between the mirror current source 51 and the resistor R, and the second input end is coupled to the reference voltage VREF, and the reference voltage VREF can be preset with pins, and the output end of the comparator is electrically coupled to the controller 53. The first input end acquires the voltage V-clkout corresponding to the clock signal current I-clkout, and compares the voltage V-clkout with the reference voltage VREF, and then outputs the comparison result to the controller 53.In the preferred embodiment, as the voltage V-clkout is larger than the reference voltage VREF, the comparator 53 determines that the clock signal current I-clkout outputted by the level translator 10 is abnormal; as the voltage does not exceed (i.e. less than or equal to) the reference voltage VREF, the comparator 53 determines that the outputted clock signal current I-clkout of the level translator 10 is normal.

The controller 53 receives the comparison result transmitted from the comparator C, and as the voltage V-clkout is larger than the reference voltage VREF, the second transistor Q2 is controlled to short the clock signal current I-clkout; according to the comparison result, as the voltage does not exceed the reference voltage VREF, the clock signal current I-clkout is kept to be outputted to the display panel 30.

In the preferred embodiment, the second transistor Q2 can be a N channel MOS transistor. A gate G of the second transistor Q2 is electrically coupled to the controller 53, and a source S of the second transistor Q2 is electrically coupled to the low voltage level node VGL, and a drain D of the second transistor Q2 is electrically coupled to the source S of the first transistor Q1 and the output node V-clkout. As the voltage V-clkout is larger than the reference voltage VREF, the controller 53 controls the second transistor Q2 to be activated to short the clock signal current I-clkout to prevent the clock signal current I-clkout burning the display panel 30.

It is understandable that the second transistor Q2 can be eliminated. In condition that the second transistor Q2 is eliminated, the controller 53 can directly control the level translator 10 to stop outputting the clock signal current I-clkout as the voltage V-clkout is larger than the reference voltage VREF.

When the liquid crystal display 100 having the protective circuit described in the embodiment of the present invention works, the level translator 10 outputs the clock signal current I-clkout to the display panel 30, and the controller 53 controls the first transistor Q1 to be activated, and the mirror current source 51 detects the clock signal current I-clkout, and the comparator C compares the voltage V-clkout corresponding to the clock signal current I-clkout with the reference voltage VREF to determine whether the clock signal current I-clkout is normal or not, and then outputs the comparison result to the controller 53. The controller 53 receives the comparison result from the comparator C and as the clock signal current I-clkout is abnormal, the second transistor Q2 is controlled to be activated and the output of the clock signal current I-clkout is short, and thus to prevent the abnormal clock signal current I-clkout from causing damage to the display panel 30. When the clock signal current I-clkout is normal, it is kept to be outputted to the display panel 30.

In conclusion, the liquid crystal display 100 having the protective circuit described in the embodiment of the present invention can detect the clock signal current I-clkout which the level translator 10 provides to the display panel 30, and compare the voltage V-clkout corresponding to the clock signal current with the reference voltage VREF to determine whether the clock signal is normal or not according to the comparison result. When the clock signal is abnormal, the output of the clock signal current I-clkout is short in time, and thus to effectively protect the display panel 30.

In the description of the present specification, the reference terms, “one embodiment”, “some embodiments”, “an illustrative embodiment”, “an example”, “a specific example”, or “some examples” mean that such description combined with the specific features of the described embodiments or examples, structure, material, or characteristic is included in the utility model of at least one embodiment or example. In the present specification, the terms of the above schematic representation do not certainly refer to the same embodiment or example. Meanwhile, the particular features, structures, materials, or characteristics which are described may be combined in a suitable manner in any one or more embodiments or examples.

Above are embodiments of the present invention, which does not limit the scope of the present invention. Any modifications, equivalent replacements or improvements within the spirit and principles of the embodiment described above should be covered by the protected scope of the invention.

What is claimed is:

1. A protective circuit, employed to protect a liquid crystal display, and the liquid crystal display comprises a display panel and a level translator providing a clock signal to the display panel through an output line, wherein the protective circuit comprises a first transistor, a detection circuit and a controller coupled to both the first transistor and the detection circuit, and the first transistor is electrically coupled to the detection circuit and the output line, and the clock signal is outputted to the display panel through the first transistor, and the detection circuit detects the clock signal and determines whether the clock signal is normal or not, and as the clock signal is abnormal, the controller controls the level translator to stop outputting the clock signal to the display panel.

2. The protective circuit according to claim 1, wherein the detection circuit comprises a mirror current source, a resistor and comparator, and the clock signal is a current, and the mirror current source detects a current outputted by the level translator, and the current flows through the resistor and grounded, and the comparator compares a voltage corresponding to the current with a reference voltage, and as the voltage is larger than the reference voltage, the comparator determines that the current outputted by the level translator is abnormal.

3. The protective circuit according to claim 2, wherein as the voltage is less than or equal to the reference voltage, the comparator determines that the output current of the level translator is normal, and the clock signal is continuously outputted to the display panel.

4. The protective circuit according to claim 2, wherein the first transistor is a P channel MOS (Metal Oxide Semiconductor) transistor.

5. The protective circuit according to claim 4, wherein the output line comprises a high voltage level node, an output node and a low voltage level node which are positioned in order, and a gate of the first transistor and is electrically coupled to the mirror current source of the detection circuit and the controller, and a drain of the first transistor is electrically coupled to the high voltage level node, and a source of the first transistor is electrically coupled to the output node; the controller can control the first transistor to be activated or to be deactivated, and as the controller controls the first transistor to be activated, the current flows from the high voltage level node to the output node through the first transistor to be provided to the display panel.

6. The protective circuit according to claim 5, wherein one end of the mirror current source is electrically coupled to the high voltage level node and the drain of the first transistor, and the other end is electrically coupled to the gate of the first transistor and the controller, and the mirror current source is further grounded through the resistor.

7. The protective circuit according to claim 6, wherein the protective circuit further comprises a second transistor, and the second transistor is electrically coupled to the output line, the first transistor and the controller, and the controller controls the second transistor to be activated to short the clock signal.

8. The protective circuit according to claim 7, wherein the second transistor is a N channel MOS transistor.

9. The protective circuit according to claim 8, wherein a gate of the second transistor is electrically coupled to the controller, and a source of the second transistor is electrically coupled to the low voltage level node, and a drain of the second transistor is electrically coupled to the output node and a gate of the first transistor.

10. A liquid crystal display comprising a level translator, a display panel and a protective circuit, and the level translator provides a clock signal to the display panel through an output line, and as the clock signal is abnormal, the protective circuit stops outputting the clock signal to the display panel; wherein the protective circuit comprises a first transistor, a detection circuit and a controller coupled to both the first transistor and the detection circuit, and the first transistor is electrically coupled to the detection circuit and the output line, and the clock signal is outputted to the display panel through the first transistor, and the detection circuit detects the clock signal and determines whether the clock signal is normal or not, and as the clock signal is abnormal, the controller controls the level translator to stop outputting the clock signal to the display panel.

11. The liquid crystal display according to claim 10, wherein the detection circuit comprises a mirror current source, a resistor and comparator, and the clock signal is a current, and the mirror current source detects a current outputted by the level translator, and the current flows through the resistor and grounded, and the comparator compares a voltage corresponding to the current with a reference voltage, and as the voltage is larger than the reference voltage, the comparator determines that the current outputted by the level translator is abnormal.

12. The liquid crystal display according to claim 11, wherein as the voltage is less than or equal to the reference voltage, the comparator determines that the output current of the level translator is normal, and the clock signal is continuously outputted to the display panel.

13. The liquid crystal display according to claim 11, wherein the first transistor is a P channel MOS (Metal Oxide Semiconductor) transistor.

14. The liquid crystal display according to claim 13, wherein the output line comprises a high voltage level node, an output node and a low voltage level node which are positioned in order, and a gate of the first transistor and is electrically coupled to the mirror current source of the detection circuit and the controller, and a drain of the first transistor is electrically coupled to the high voltage level node, and a source of the first transistor is electrically coupled to the output node; the controller can control the first transistor to be activated or to be deactivated, and as the controller controls the first transistor to be activated, the current flows from the high voltage level node to the output node through the first transistor to be provided to the display panel.

15. The liquid crystal display according to claim 14, wherein one end of the mirror current source is electrically coupled to the high voltage level node and the drain of the first transistor, and the other end is electrically coupled to the gate of the first transistor and the controller, and the mirror current source is further grounded through the resistor.

16. The liquid crystal display according to claim 15, wherein the protective circuit further comprises a second transistor, and the second transistor is electrically coupled to the output line, the first transistor and the controller, and the controller controls the second transistor to be activated to short the clock signal.

17. The liquid crystal display according to claim 16, wherein the second transistor is a N channel MOS transistor.

18. The liquid crystal display according to claim 17, wherein a gate of the second transistor is electrically coupled to the controller, and a source of the second transistor is electrically coupled to the low voltage level node, and a drain of the second transistor is electrically coupled to the output node and a gate of the first transistor.
